(19) United States
(12) Patent Application Publication
(10) Pub. No.: US 2006/0211562 A1
(43) Pub. Date: Sep. 21, 2006

(54) Fiberglass composition for insulation fiber in rotary fiberization process

(76) Inventor: Diana Kim Fisler, Littleton, CO (US)

Correspondence Address: JOHNS MANVILLE INTERNATIONAL, INC., 717 SEVENTEENTH STREET, DENVER, CO, 80202, US

(21) Appl. No.: 11/083,326

(22) Filed: Mar. 18, 2005

(51) Int. Cl. C03B 37/04; C03C 13/06; C03C 3/091

(52) U.S. Cl. 501/36; 65/470; 65/455; 501/66

(57) ABSTRACT

Glass compositions suitable for rotary fiberization. The compositions contain SiO₂ in an amount of about 49-56 wt %, Al₂O₃ in an amount of about 5.0-8.0 wt %, B₂O₃ in an amount of about 10-15 wt %, RO (MgO+CaO) in an amount of about 8-11 wt %, and R₂O (Na₂O+K₂O) in an amount of about 18-25 wt %. The compositions have an HTV in the range of about 1675°-1775° F. and a liquidus at least 100° F. below the HTV.

### BACKGROUND OF THE INVENTION

1. Field of the Invention

The present invention relates to glass fiber compositions and, more particularly, to the formation of glass fibers which, due to their composition, exhibit a lower viscosity during fiberization, thereby permitting increased productivity and reduced operating temperatures.

2. Description of the Related Art

Glass fibers are typically manufactured by a number of different processes. One of these is a so-called rotary or centrifuge technique. The rotary technique involves feeding a molten glass material to a rapidly rotating disk or spinner. As the spinner rotates at a high speed, glass strands are extruded through orifices located in the spinner by centrifugal force. Upon exiting from the spinner, the extruded strands are subjected to a stream of hot gas which attenuates the fibers. During the rotary operation, the liquidus temperature, i.e., the temperature at which the growth rate of crystals within the glass becomes zero, must be kept lower than the HTV (High Temperature Viscosity), i.e., the temperature at which the molten glass has a viscosity of 10³ poises. This minimizes the risk of crystal formation within the centrifuge apparatus. Otherwise, crystals might block the orifices of the apparatus and prevent the glass from exiting.

In preparing glass fibers useful in the manufacture of insulation products, the HTV during rotary fiberization is normally maintained below about 2000° F., preferably below about 1900° F. and most preferably in the range of about 1820°-1840° F. The liquidus temperature should be at least 100° F. below the HTV to avoid the formation of crystals in the glass. Thus, glass forming compositions intended for use in conventional rotary spinning fiberization processes must have properties, including melt viscosity, which are tailored to conform to the desired process specifications and product characteristics. The produced fibers must have acceptable physical properties, e.g., tensile strength, thermal efficiency, moisture resistance, etc.

Glass compositions selected for rotary fiberization must be capable of being melted and fiberized at temperatures high enough to maintain low viscosity without crystal formation but low enough to avoid excessive wear-and-tear of the equipment while maintaining effective production rates. Glass formulations which would enable one to operate at a lower HTV than conventionally used would result in lower operating temperatures and increase productivity.

The diameter of glass fibers manufactured by rotary spinning depends upon a number of factors including the viscosity of the molten glass, the spinner RPM and the pull rate. The viscosity of the molten glass depends upon the temperature of the molten glass, and the spinner disk can be operated at a temperature proportionally lower to provide the same glass viscosity, for example, at least 100° F. or 150° F. lower. The corrosion of spinner disks is a major factor which determines disk life and corrosion is exponentially dependent on process temperature. Lowering the glass temperature by 100° F., for example, can provide as much as a 200% increase in disk life. This increased disk life potentially could result in savings of several millions of dollars in operating costs.

Moreover, a lower viscosity glass would provide easier attenuation of the fibers and the fiber diameter would be smaller at higher pull rates which still operating at standard temperatures. This would increase production rates and provide improved economic benefits.

Glass compositions which provide the above advantages, i.e. acceptable physical properties and lower viscosity for increased throughput and reduced operating temperatures, would be highly desirable and valuable to the industry.

### SUMMARY OF THE INVENTION

It has now been discovered that glass compositions can be prepared which are eminently suitable for rotary fiberization and produce glass fibers having excellent physical properties. The compositions provide molten glass which can be rotary fiberized at lower temperatures and viscosities thereby resulting in lower maintenance costs and increased production.

The glass compositions of the invention contain SiO₂ in an amount ranging from about 49 wt % to about 56 wt %, Al₂O₃ in an amount ranging from about 5.0 wt % to about 8.0 wt %, B₂O₃ in an amount ranging from about 10 wt % to about 15 wt %, RO ranging from about 8% by weight to about 11% by weight, where R is Ca and/or Mg, and R₂O in an amount ranging from about 18 wt % to about 25 wt %, where R₂ is K and/or Na. The glass fiber compositions should have an HTV of about 1675° F. to about 1775° F. and a liquidus at least 100° F. below the HTV.

### DESCRIPTION OF THE PREFERRED EMBODIMENTS

The glass fiber compositions of the invention have relatively lower silica and alumina contents and relatively higher boron and soda contents than glass compositions traditionally used in rotary fiberization methods. The silica (SiO₂) content should be in the range of about 49-56 wt %, preferably about 50-52 wt %, based on the total weight of the composition. The alumina component (Al₂O₃) should be present in an amount of about 5.0 to 8.0 wt %, more preferably from 5.5-7.5 wt %, and most preferably from about 6-7 wt %. The boron oxide component (B₂O₃) should be present in an amount ranging from about 10-15 wt %, preferably about 12-13 wt %.

The component RO in the compositions of the present invention is a mixture of magnesium oxide (MgO) and calcium oxide (CaO). The total amount of this alkaline earth metal oxide mixture ranges from about 8 wt % to about 11 wt %, preferably about 9-10 wt %. The CaO preferably is present in an amount of about 4-6 wt %, and most preferably in the range of from about 5-6 wt %, while the MgO preferably is present in an amount of about 3-5 wt %, and most preferably from 3.5-4.5 wt % based on the total weight of the glass composition.

The component R₂O in the glass compositions of the invention is generally a blend of sodium oxide (Na₂O) and potassium oxide (K₂O). The total amount of the alkali metal oxides ranges from about 18-25 wt %, preferably about 18-20 wt %. The Na₂O preferably is present in an amount of about 17-18 wt % and the K₂O preferably is present in an amount ranging from about 1-2 wt %.

The molten glass compositions of the invention should have an HTV of between about 1675° and 1775° F., more preferably from 1690° to 1750° F., and most preferably from about 1700° to 1730° F., and a liquidus at least 100° F., preferably 150° F., below the HTV in order to yield glass fibers having acceptable physical properties and also attain the aforementioned benefits of the invention, i.e., lower viscosity glass, lower operating temperatures, increased disk life, increased production, etc. This is accomplished in part by reducing the content of silica, alumina and alkaline earth metal oxides and increasing boron oxide and soda contents.

Moisture resistance of the fibers obtained in accordance with the invention is high enough to provide long term recovery under humid conditions. This is provided by increasing the alumina content to greater than 5 wt %, and preferably within the range of 5.5 wt % to 7.5 wt %. The liquidus must be at least 100° F., preferably at least 150° F., below the HTV to avoid crystallization in the spinner which would shorten disk life. This is accomplished by limiting the CaO+MgO content to below 11 wt %, i.e., in the range of 8-11 wt %.

Heat capacity of the glass formulations of the invention unexpectedly is higher than formulations currently used in rotary fiberization techniques, thereby allowing for a more stable process operation. Using current measurements, the heat capacity of glass formulations of the invention is about 0.40 BTU/lb. ° F. as opposed to standard glass with a measured heat capacity of about 0.30 BTU/lb. ° F. The use of increased levels of boron oxide is believed to provide the higher heat capacity. In addition, the higher boron oxide content provides better thermal performance per lb of glass, increasing the possible throughput over and above the effect of lower viscosity.

Various other constituents for improving the glass compositions and/or resulting properties may be present in the glass fiber compositions provided herein. Some constituents may also be present as impurities without adversely affecting the glass compositions or the resultant glass fibers. Such impurities should not be present in concentrations greater than about 2.0 weight percent, as the presence of such impurities may alter the positive effects of other constituents in the glass fiber compositions of the present invention.

The invention is further illustrated by the following examples of suitable compositions of the present invention, which are not to be construed as limitative of its scope.

| | EXAMPLE 1 | EXAMPLE 2 |
|---|---|---|
| Ingredient | Wt % | Wt % |
| SiO₂ | 51.90 | 52.00 |
| Al₂O₃ | 6.67 | 6.27 |
| B₂O₃ | 12.29 | 12.92 |
| Na₂O | 18.00 | 17.50 |
| K₂O | 1.44 | 1.36 |
| CaO | 5.68 | 5.83 |
| MgO | 3.95 | 4.06 |

Although the invention has been described in detail in the foregoing for the purpose of illustration, it is to be understood that such detail is solely for that purpose and that variations can be made therein by those skilled in the art without departing from the spirit and scope of the invention.

1. A glass fiber composition suitable for rotary fiberization comprising:
about 49% to 56% by weight of SiO₂,
about 5.0% to 8.0% by weight of Al₂O₃,
about 10% to 15% by weight of B₂O₃,
about 8% to 11% by weight of a mixture of CaO and MgO, and
about 18% to 25% by weight of a mixture of K₂O and Na₂O,
the composition having an HTV of about 1675° F. to about 1775° F. and a liquidus at least 100° F. below the HTV.

2. The composition according to claim 1, comprising the following ingredients in percent by weight based on the total weight of the composition:
SiO₂—about 50% to about 52%,
Al₂O₃—about 5.5% to about 7.5%,
B₂O₃—about 12% to about 13%,
R₂O—about 18% to about 20%, and
RO—about 9% to about 10%,
where R₂ is a mixture of K and Na and R is a mixture of Ca or Mg.

3. The composition according to claim 2, where Na₂O is about 17-18% and K₂O is about 1-2%, and CaO is about 4-6% and MgO is about 3-5%.

4. The composition according to claim 1, wherein the HTV ranges from about 1690° F. to about 1750° F.

5. The composition according to claim 4, wherein the HTV is within the range of about 1700° F. to about 1730° F.

6. A method of manufacturing glass fibers by rotary fiberization which comprises:
(a) introducing a molten glass composition onto a rapidly rotating spinner;
(b) extruding the molten glass composition through orifices in the spinner to obtain glass fibers;
(c) attenuating the fibers, and
(d) collecting the glass fibers,
wherein the molten glass composition comprises about 49% to 56% by weight SiO₂, about 5% to 8% Al₂O₃, about 10% to 15% by weight B₂O₃, about 8% to 11% by weight of a mixture of CaO and MgO, and about 18% to 25% by weight of a mixture of K₂O and Na₂O, the molten glass composition has an HTV of about 1675° F. to about 1775° F. and a liquidus of at least 100° F. below the HTV.

7. The method according to claim 6, where the glass composition comprises:
SiO₂—about 50% to about 52%,
Al₂O₃—about 5.5% to about 7.5%,
B₂O₃—about 12% to about 13%,
R₂O—about 18% to about 20%, and
RO—about 9% to about 10%,
where R₂ is a mixture of K and Na and R is a mixture of Ca and Mg.

8. The method according to claim 7, wherein Na₂O is about 17-18% and K₂O is about 1-2%, and CaO is about 4-6% and MgO is about 3-5%.

9. The method according to claim 6, wherein the HTV ranges from about 1690° F. to about 1750° F.

10. The method according to claim 9, wherein the HTV is within the range of about 1700° F. to about 1730° F.

11. Glass fibers prepared by the method of claim 6.
